(19) United States
(12) Patent Application Publication
(10) Pub. No.: US 2026/0120666 A1
(43) Pub. Date: Apr. 30, 2026

(54) ELECTRONIC AFRICAN DRUM AND DRUM HEAD MANUFACTURING PROCESS

(71) Applicant: Aroma Technology Co., Limited, Huizhou (CN)

(72) Inventors: Haihua CHEN, Huizhou (CN); Zhi ZHANG, Huizhou (CN); Benfeng GONG, Huizhou (CN); Chenglong LI, Huizhou (CN)

(21) Appl. No.: 19/380,944

(22) Filed: Nov. 5, 2025

(30) Foreign Application Priority Data
Sep. 4, 2025 (CN) 2025112584435

(51) Int. Cl. G10D 13/20

(52) U.S. Cl. CPC G10D 13/20

(57) ABSTRACT

The present disclosure relates to an electronic African drum and a drum head manufacturing process. The electronic African drum comprises a drum body and a drum head, wherein the drum head is made of ETPU materials; the drum head is circular, and a flange and an extension part are arranged on the drum head; an adhesive layer is arranged on one side of the drum head; the drum body also comprises a cavity, in which a supporting component is arranged; the supporting component comprises a metal plate, a buffer and a bracket. The drum head significantly reduces peak instantaneous impact while preserving or approximating traditional tone and tactile feel; the center and edge areas of the drum head are differentiated by a flange structure to produce distinct sounds; the supporting component is abutted against the drum head, reducing deformation and slack during use.

### TECHNICAL FIELD

The present disclosure relates to the technical field of electronic musical instruments, particularly to an electronic African drum and a drum head manufacturing process.

### BACKGROUND ART

For traditional African drums, the drum heads are typically made of goat skin, cowhide or synthetic materials (such as PVC), while the drum bodies are often hollowed out from a single piece of wood. Although this traditional crafting technique preserves ethnic aesthetics and acoustic characteristics, it reveals significant limitations in modern usage scenarios.

Firstly, natural hides and some synthetic materials have high surface hardness but insufficient elasticity and cushioning. When a performer strikes the drum head directly with palms or fingers, the impact force cannot be effectively dispersed or absorbed. This results in high-impact stress concentrated on the palms, finger joints and fingertips, often causing pain, redness, swelling, and even skin abrasions. Such limitations restrict the duration and intensity of continuous practice, thereby reducing learning efficiency and popularity.

Secondly, constrained by materials and craftsmanship, the traditional wooden drum bodies are mostly hollowed out from a single piece of wood or spliced from multiple pieces. This results in heavier drum bodies, increasing the burden of transportation and carrying, which is unfavorable for street performances, mobile teaching and live tours. On the other hand, the thick wooden structure demands higher durability for long-term handling, making it prone to issues such as cracking, deformation or loose seams. Additionally, natural wood and hides are sensitive to environmental humidity and temperature. Exposure to moisture or dryness can cause changes in drum tension, pitch instability and crack risk, thereby increasing maintenance frequency and usage costs.

### SUMMARY OF THE PRESENT DISCLOSURE

Based on the technical problems existing in the background art, the present disclosure proposes an electronic African drum and a drum head manufacturing process.

The electronic African drum proposed by the present disclosure comprises a drum body and a drum head, wherein the drum head is made of ETPU materials;
the drum head is arranged at one end of the drum body, an adhesive layer is arranged on one side of the drum head, and the drum head is adhered and bonded to the drum body through the adhesive layer;
the drum head is circular, and a flange and an extension part are arranged on the drum head and located on the same side of the drum head;
the drum body also comprises a cavity, and a supporting component is arranged in the cavity and abutted against the drum head to support the drum head;
the supporting component comprises a metal plate, a buffer and a bracket;
the bracket is fixedly arranged in the cavity, and the buffer and the metal plate are successively arranged on the bracket;
the metal plate is located between the drum head and the buffer and abutted against the drum head to provide support.

Further, the flange comprises a first flange and a second flange; the first flange and the second flange are respectively ring-shaped and located on the side of the drum head close to the supporting component;
the first flange is arranged close to the center of the drum head, and the second flange is arranged on the outside of the first flange.

Further, a third flange protruding outward is arranged at one end of the drum body abutted against the drum head and engages with the extension part.

Further, a placement slot is arranged on the bracket, and the buffer and the metal plate are respectively placed in the placement slot in sequence.

Further, the first flange, the second flange and the extension part are integrally formed with the drum head.

A drum head manufacturing process comprises the following steps:
S1. Pre-foam thermoplastic polyurethane (TPU) pellets;
S2. Place the pre-foamed ETPU beads into a drum head mold for heating and softening, and then fuse them into a complete drum head;
S3. Move the drum head to a cutting fixture for trimming;
S4. Apply adhesive to one side of the drum head using coating equipment to form the adhesive layer.

Further, the steps for pre-foaming the thermoplastic polyurethane (TPU) pallets also comprise:
adjust the foaming ratio by regulating gas pressure, temperature and soaking time to control the density and hardness of the drum head.

Further, after the step of pre-foaming the thermoplastic polyurethane (TPU) pellets, the process further comprises the following step:
cool and shape the foamed TPU beads to obtain ETPU beads.

Further, after the step of placing the pre-foamed ETPU beads into the drum head mold for heating and softening and then fusing them into the complete drum head, the process further comprises the following step:
stop conveying high-temperature steam into the drum head mold, and lower the temperature of the mold cavity through cooling water or compressed air to obtain the finished drum head product with the set shape and size.

Further, after the step of moving the drum head to the cutting fixture for trimming, the process further comprises the following step:
move the drum head from the cutting fixture to the coating equipment, and apply adhesive to the side of the drum head abutted against the supporting component.

The present disclosure has the following beneficial effects: the drum head is made of ETPU material, and the drum body is made of ABS polymer material. Compared to solid materials, the overall drum head is lighter and easier to carry, install and move. Meanwhile, the low-density drum head design facilitates sustain control and provides a softer tactile feel. Additionally, the drum head offers excellent rebound rate, sensitive striking feel and instant energy feedback, exhibits high wear resistance and durability, withstands frequent striking, maintains durable appearance and requires less frequent drum head replacement. Furthermore, the drum head has temperature resistance as the ETPU material maintains stable performance across a wide temperature range; the drum head has chemical resistance, making it less prone to degradation or discoloration due to sweat or cleaning over long-term use, and having low maintenance costs. The drum head made of ETPU material significantly reduces peak instantaneous impact while retaining or approaching traditional tone and tactile feel, thereby enhancing striking sensitivity and comfort.

Additionally, the center and edge areas of the drum head are differentiated by a flange structure. By arranging the flange close to the side wall of the cavity, distinct trigger areas can be accurately divided, allowing the system to more easily locate the edge of the drum head and activate different trigger modes to produce varied sounds or effects. The center area of the drum head is abutted against the support structure inside the cavity, reducing deformation and slack during use and ensuring the stability and durability of the drum body. Furthermore, the adhesive layer is arranged on one side of the drum head and bonds to the supporting component, reducing the trigger delay or false trigger caused by unstable vibration or looseness, and enhancing the response speed of the electronic African drum.

### BRIEF DESCRIPTION OF THE DRAWINGS

FIG. 1 is a structural diagram of the electronic African drum in the embodiments of the present disclosure.

FIG. 2 is a stereoscopic diagram of the drum head of the electronic African drum in the embodiments of the present disclosure.

FIG. 3 is a front view of the drum head of the electronic African drum in the embodiments of the present disclosure.

FIG. 4 is a section view of A-A in FIG. 3.

FIG. 5 is an assembly diagram of the electronic African drum in the embodiments of the present disclosure.

FIG. 6 is a section view of B-B in FIG. 5.

FIG. 7 is a flowchart of the drum head manufacturing process for the electronic African drum in the embodiments of the present disclosure.

Reference signs: drum body 1, cavity 11, third flange 12; drum head 2, adhesive layer 21, flange 22, first flange 221, second flange 222, extension part 23; supporting component 3, metal plate 31, buffer 32, bracket 33, placement slot 331.

### DETAILED DESCRIPTION

To clarify the objectives, technical proposals and advantages of the embodiments of the present disclosure, the following will provide a clear and comprehensive description of the technical proposals in the embodiments of the present disclosure. Obviously, the described embodiments are part of the embodiments of the present disclosure, rather than all of them. Based on the embodiments of the present disclosure, all other embodiments obtained by those of ordinary skill in the art without creative efforts shall fall within the protection scope of the present disclosure.

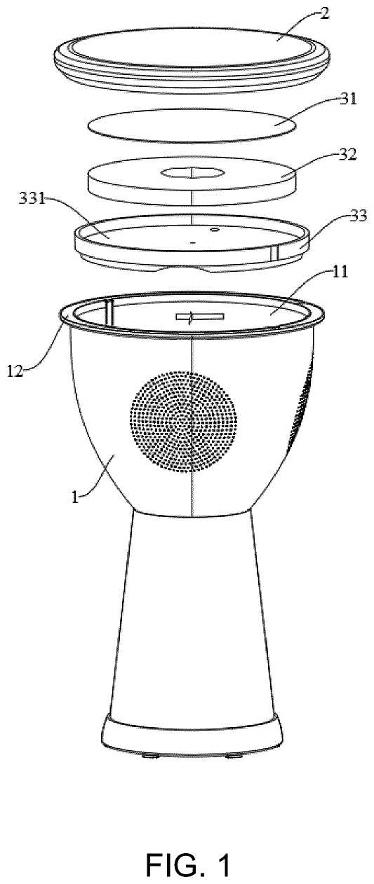

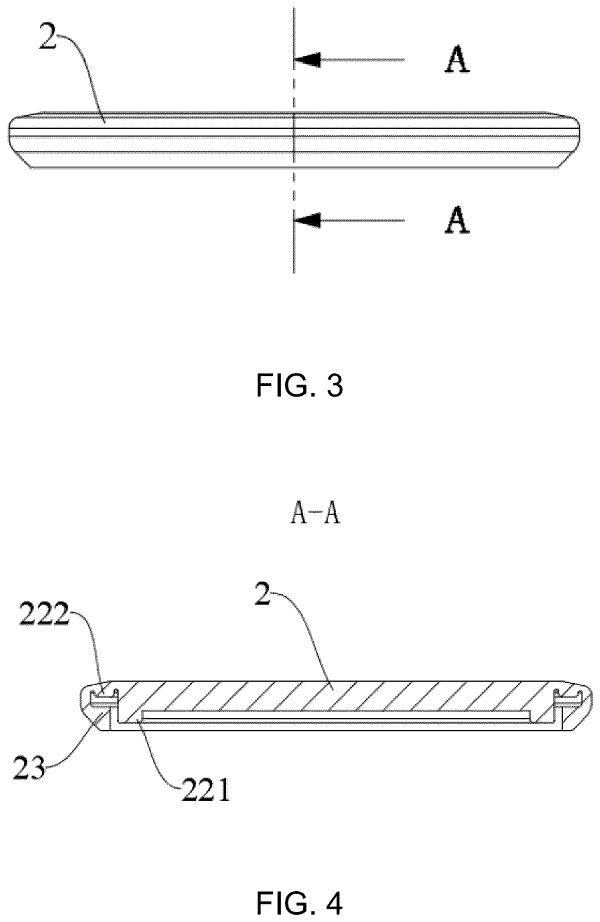

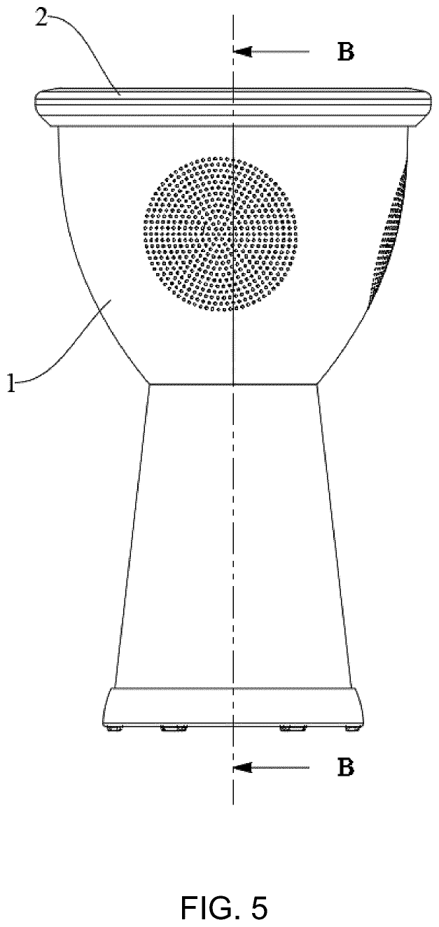

As shown in FIGS. 1-6, the present disclosure proposes an electronic African drum, comprising a drum body 1 and a drum head 2, wherein the drum head 2 is made of ETPU materials; the drum head 2 is arranged at one end of the drum body 1, an adhesive layer 21 is arranged on one side of the drum head 2, and the drum head 2 is adhered and bonded to the drum body 1 through the adhesive layer 21; the drum head 2 is circular, and a flange and an extension part 23 are arranged on the drum head 2 and located on the same side of the drum head 2; the drum body 1 also comprises a cavity 11, and a supporting component 3 is arranged in the cavity 11 and abutted against the drum head 2 to support the drum head 2; the supporting component 3 comprises a metal plate 31, a buffer 32 and a bracket 33; the bracket 33 is fixedly arranged in the cavity 11, and the buffer 32 and the metal plate 31 are successively arranged on the bracket 33; the metal plate 31 is located between the drum head 2 and the buffer 32 and abutted against the drum head 2 to provide support.

In some embodiments, both ends of the drum body 1 are circular, and the shape of the drum head 2 corresponds to that of the drum body 1; the drum head 2 is arranged at one end of the drum body 1, a cavity 11 is arranged at one end of the drum body 1 near the drum head 2, and a supporting component 3 is arranged inside the cavity 11 to support the drum head 2. During assembly, the drum head 2 is abutted against and clamped on the drum body 1 to allow the cavity 11 of the drum body 1 to be enclosed. The cavity 11 can accommodate the supporting component 3 and electronic components (such as sensors, circuit boards, batteries, speakers, etc.). The supporting component 3 comprises the metal plate 31, the buffer 32 and the bracket 33; the bracket 33 is fixedly arranged in the cavity 11 of the drum body 1, and a placement slot 331 is arranged on the bracket 33, specifically located on the side of the bracket 33 close to the drum head 2 and recessed in the direction away from the drum head 2; the buffer 32 and the metal plate 31 are respectively placed in the placement slot 331 in sequence. Specifically, the metal plate 31 is located between the buffer 32 and the drum head 2; one side of the metal plate 31 is abutted against the buffer 32, and the other side thereof is abutted against the drum head 2 to support the drum head 2, reduce the deformation and relaxation of the drum head 2 during use and ensure the stability and durability of the drum body 1.

An adhesive layer 21 is arranged on one side of the drum head 2 and specifically located on the side of the drum head 2 close to the supporting component 3; the adhesive layer 21 is applied with strong adhesive for bonding. After the drum head 2 is adhered to the metal plate 31, vibration generated by striking the drum head 2 is distributed to trigger components under the drum head 2 through the metal plate 31, thereby reducing trigger delay or false trigger caused by unstable vibration or looseness, enhancing the response speed of the electronic drum, and ensuring more stable trigger and minimal positional variation impact of the drum head 2. Additionally, the metal plate 31 disperses impact forces, preventing damage to electronic components by single points and extending the life of the electronic components inside the cavity 11 of the drum body 1. Moreover, the adhesion ensures a more compact structure between the drum head 2 and the drum body 1, making the drum head 2 less prone to displacement or deformation.

In some embodiments, the drum head 2 (i.e., the drum skin) of the drum body 1 is one of the most critical components of the electronic drum and directly impacts the playing experience, sound effect, durability and touch authenticity. The drum head 2 in the present disclosure is made of expanded thermoplastic polyurethane (ETPU) microcellular foam material and has the following characteristics: after foaming, TPU has low density, significantly reducing weight compared to solid materials; the overall drum head 2 is lighter, facilitating portability, installation and mobility; additionally, the low-density drum head 2 contributes to better sustain control and softer tactile feel; by adjusting the foaming density, the hardness of the drum head 2 can be regulated, enabling varying levels of percussion tactile feel to accommodate different playing styles and preferences. The drum head 2 has excellent rebound rate greater than or equal to 65%, high energy feedback efficiency, sensitive percussion feel and instant energy feedback, making it suitable for performances requiring fast, continuous percussion or sensitive feedback. The drum head 2 has high wear resistance and durability. ETPU can effectively absorb impact energy, such as 80%-90% of impact energy, reducing peak reacting force and minimizing vibration transmission. Moreover, Akron abrasion loss is less than or equal to 0.05 cm3/1.61 km, outperforming 0.1-0.2 cm3/1.61 km of EVA. The drum head 2 resists frequent striking wear, maintains durable appearance and has low replacement frequency, making it suitable for high-intensity practice or performances. In terms of temperature resistance, compared to ethylene-vinyl acetate copolymer (EVA) which tends to harden and become brittle at low temperatures, ETPU maintains stable performance across a wide temperature range, for example, maintain good elasticity at −40 to 80 degrees C. In terms of chemical resistance, the main chain of TPU contains urethane bonds, providing chemical stability superior to ordinary plastics and resists hydrolysis, oil stains, acids and alkalis. TPU is easier to clean due to non-porous surface structure and less prone to degradation or discoloration due to sweat or cleaning over long-term use, resulting in low maintenance costs.

Wherein, the drum body 1 is made of ABS polymer material, which significantly reduces the weight of the drum body 1 and is not sensitive to humidity and enhances learning efficiency and popularity unlike natural wood which is prone to moisture-induced pitch distortion, cracking or shrinkage.

In some embodiments, a flange 22 and an extension part 23 are arranged on the drum head 2 and located on the same side of the drum head 2, specifically on the side of the cavity 1 close to the drum body 1 and at the edge of the circular drum head 2. During assembly, one part of the flange 22 of the drum head 2 is abutted against the drum body 1, while another part is embedded into the cavity 11 and abutted against the inner wall of the cavity 11, ensuring a more secure connection between the drum head 2 and the drum body 1. The extension part 23 is located outside the flange 22 of the drum head 2. The extension part 23 extends away from the center of the drum head 2 and curls back toward the center at the edge of the drum head 2, forming a rolled-edge structure. The rolled-edge structure is close to the drum body 1, and the shape of the side abutted against the drum body 1 corresponds to that of the drum body 1.

As shown in FIG. 4, the flange 22 comprises a first flange 221 and a second flange 222; the first flange 221 and the second flange 222 are respectively ring-shaped and located on the side of the drum head 2 close to the supporting component 3; the first flange 221 is arranged close to the center of the drum head 2, and the second flange 222 is arranged on the outside of the first flange 221.

During specific implementation, the flange 22 comprises a first flange 221, a second flange 222 and a third flange 12, wherein the first flange 221 and the second flange 222 are located on the drum head 2, while the third flange 12 is located on the drum body 1. The first flange 221, the second flange 222 and the third flange 12 are respectively annular; the first flange 221 and the second flange 222 are respectively located on the side of the drum head 2 close to the cavity 11 of the drum body 1; the third flange 12 is located on the outer edge of the cavity 11 and protrudes outwards the cavity 11 of the drum body 1. During assembly, the first flange 221 of the drum head 2 is arranged next to the cavity 11 of the drum body 1, while the second flange 222 is located above the third flange 12 of the drum body 1. When struck, the second flange 222 can be abutted against the third flange 12. A center striking trigger system and an edge striking trigger system are arranged on the drum body 1. The first flange 221 and the second flange 222 can be used to distinguish between the trigger areas of the drum edge and the drum center. In the electronic drum system, striking the edge and center of the drum head 2 can trigger different sound effects or tones. By incorporating the flange 22 structure and positioning the flange 22 close to the side wall of the cavity 11, different trigger areas can be precisely divided, allowing the system to more easily locate the edge of the drum head 2 and activate different trigger modes to produce varied sounds or effects.

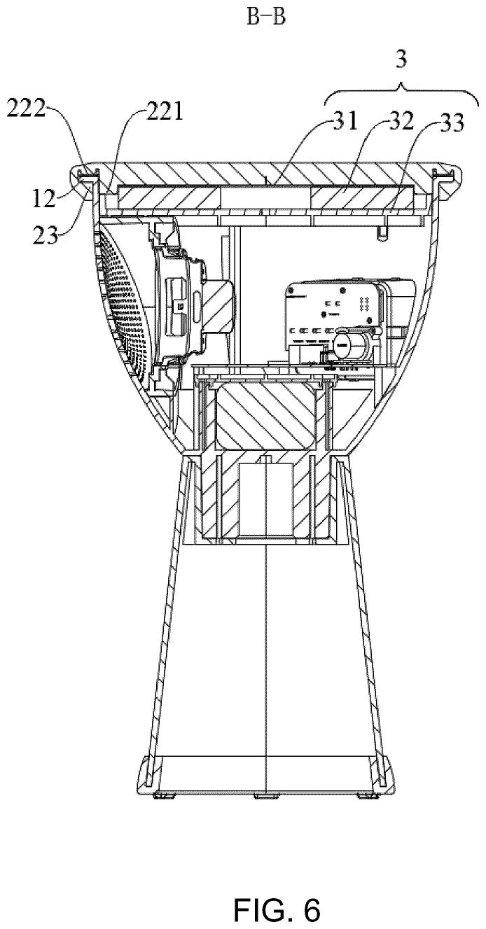

As shown in FIG. 1 and FIG. 6, a third flange 12 protruding outward is arranged at one end of the drum body 1 abutted against the drum head 2 and engages with the extension part 23.

Specifically, a third flange 12 protruding outward is arranged at one end of the drum body 1 abutted against the drum head 2. During assembly, the second flange 222 of the drum head 2 is located on the upper surface of the third flange 12 of the drum body 1; the first flange 221 is embedded into the cavity 11; the portion of the drum head 2 near the center is abutted against the supporting component 3 inside the cavity 11; the rolled-edge structure formed by the extension part 23 of the drum head 2 encloses the third flange 12 of the drum body 1 and is abutted against both the lower surface of the third flange 12 and the outer surface of the drum body 1, ensuring that the extension part 23 of the drum head 2 engages securely with the third flange 12 of the drum body 1.

As shown in FIG. 1 and FIG. 6, a placement slot 331 is arranged on the bracket 33, and the buffer 32 and the metal plate 31 are respectively placed in the placement slot 331 in sequence.

During specific implementation, the supporting component 3 comprises the metal plate 31, the buffer 32 and the bracket 33; the bracket 33 is fixedly arranged inside the cavity 11 of the drum body 1. The bracket 33 provides a stable space for securing piezoelectric sensors, vibration sensors, wires and other electronic components to ensure that the sensors and other electronic components do not shift or be damaged during long-term use, thereby enhancing the stability and accuracy of the electronic African drum.

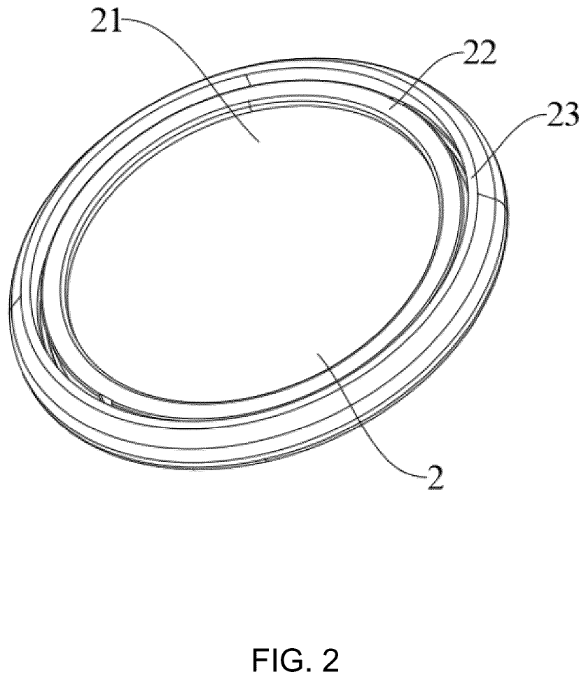

As shown in FIGS. 2-4, the first flange 221, the second flange 222 and the extension part 23 are integrally formed with the drum head 2.

During specific implementation, The design of the first flange 221 and the second flange 222 effectively disperses the impact force, reducing the direct pressure on the center of the drum head 2, enhancing the rigidity of the drum head 2, minimizing edge bending or deformation under intense striking and thereby improving the durability of the drum head 2. The first flange 221 and the second flange 222 are integrally formed with the drum head 2, ensuring uniform tension across the drum head 2, establishing a physical foundation for precise and reliable trigger, and ensuring consistent response to every strike. The first flange 221, the second flange 222 and the extension part 23 are combined with the drum head 2 through a mold to form a complete drum head 2 without any assembly parts, eliminating the subsequent assembly steps and reducing costs. The monolithic structure creates a continuous, seamless interface at the juncture of the first flange 221, the second flange 222 and the extension part 23, effectively preventing dust, liquid, sweat and other foreign matters from entering the drum cavity, protecting the delicate circuit boards and electronic components, and thereby extending their lifespan.

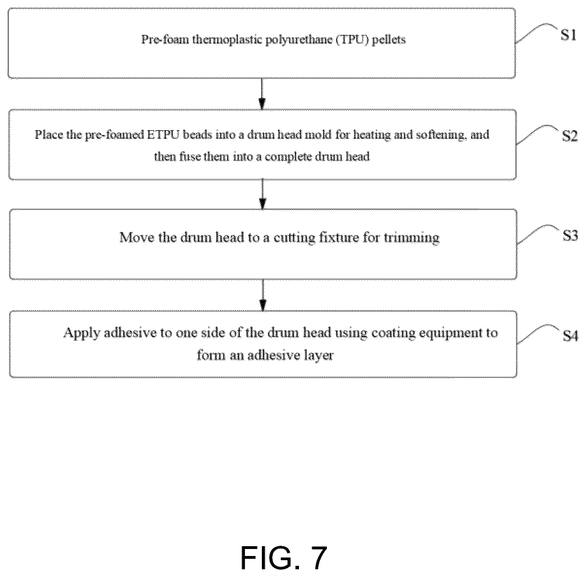

As shown in FIG. 7, the present disclosure proposes a drum head 2 manufacturing process for the electronic African drum, comprising the following steps:
S1. Pre-foam thermoplastic polyurethane (TPU) pellets;
S2. Place the pre-foamed ETPU beads into a drum head 2 mold for heating and softening, and then fuse them into a complete drum head 2;
S3. Move the drum head to a cutting fixture for trimming;
S4. Apply adhesive to one side of the drum head 2 using coating equipment to form the adhesive layer 21.

In some embodiments, the steps for pre-foaming the thermoplastic polyurethane (TPU) pallets also comprise: adjust the foaming ratio by regulating gas pressure, temperature and soaking time to control the density and hardness of the drum head 2.

The specific process is as follows: foam the pre-prepared thermoplastic polyurethane (TPU) pellets, place the TPU pellets in a pressure vessel (such as an autoclave), use a supercritical fluid (e.g., supercritical carbon dioxide) as a foaming agent, and inject carbon dioxide (CO2) into the autoclave and maintain at set high temperature and pressure for a certain period. In a supercritical state, carbon dioxide exhibits excellent solubility, allowing the supercritical fluid to fully penetrate and dissolve into the molecular chains of the TPU pellets, and promoting the foaming of the TPU pellets. During the supercritical foaming process, carbon dioxide needs to be heated above its critical temperature (31.1 degrees C.) and critical pressure (7.38 MPa) to enter the supercritical state. TPU pellets are mixed with supercritical carbon dioxide, and the foaming ratio is controlled by adjusting the gas pressure, temperature, and soaking time in the pressure vessel. Once the TPU pellets have fully dissolved the supercritical carbon dioxide, carbon dioxide can be changed from the supercritical state to the conventional gaseous state through rapid depressurization, thereby yielding ETPU beads. The ETPU beads are then filled into the cavity of the drum head 2 mold for hot press molding. During the hot press molding process, high-temperature saturated steam is injected into the drum head 2 mold. The heat from the steam is rapidly transferred to the ETPU beads, softening their surfaces to a viscous flow state. The steam pressure compresses the ETPU beads, ensuring close contact and mutual adhesion. Under the combined action of heat and pressure, the molten surfaces of adjacent ETPU beads fuse together, ultimately forming an integrated component. Wherein, the hardness of the drum head 2 is highly positively correlated with its density: the higher the density is, the higher the hardness typically is; the lower the density is, the softer the drum head 2 becomes. The softness and hardness of the drum head 2 can be adjusted by controlling the foaming ratio. The softness and hardness of the drum head 2 can be controlled within the range of 50-85 A and can be adjusted according to actual needs to suit different scenarios and different types of drum bodies 1. Additionally, the hot press molded drum head 2 may have some excess flash (caused by the extrusion of fused ETPU beads), and the drum head 2 needs to be trimmed. The molded drum head 2 can be moved to a cutting fixture for trimming. Meanwhile, the trimmed flash can be recycled and processed into washers, acoustic insulation pads or buffer blocks through injection molding or extrusion, which can be used as foot pads or non-critical performance components for the drum body 1.

In some embodiments, after the step of pre-foaming the thermoplastic polyurethane (TPU) pellets, the process further comprises the following step: cool and shape the foamed TPU beads to obtain ETPU beads.

During specific implementation, after depressurization, the foam structure of the foamed TPU beads remains in a high-temperature and unstable state. The molded foam structure is required to be cooled and shaped to prevent the foam structure from merging or collapsing. The ETPU beads extracted from the supercritical foaming reactor need to be left standing for a period of time to allow the internal pressure and residual gas distribution within the beads to reach equilibrium, ensuring stable and consistent expansion performance during subsequent steam molding. The foamed ETPU beads exhibit characteristics such as light weight, high elasticity and excellent thermal insulation, making them ideal properties for the drum head 2.

In some embodiments, after the step of placing the pre-foamed ETPU beads into the drum head mold for heating and softening and then fusing them into the complete drum head 2, the process further comprises the following step: stop conveying high-temperature steam into the drum head 2 mold, and lower the temperature of the mold cavity through cooling water or compressed air to obtain the finished drum head 2 product with the set shape and size.

During specific implementation, place the foamed ETPU beads into the drum head 2 mold, and set appropriate temperature and pressure to melt the ETPU beads. Under the combined action of heat and pressure, the molten surfaces of adjacent beads diffuse and fuse with each other, forming strong welding points, and ultimately bonding into a single integrated structure. After the beads are fully fused, stop injecting the steam, and inject cooling water into the cooling channel of the drum head 2 mold or use compressed air to rapidly lower the temperature of both the mold and the drum head 2. This ensures that the fused ETPU solidifies and sets, preventing deformation or shrinkage. Once the drum head 2 mold is cooled to the set temperature, open the drum head 2 mold, and remove the molded drum head 2 from the mold.

In some embodiments, after the step of moving the drum head 2 to the cutting fixture for trimming, the process further comprises the following step: move the drum head 2 from the cutting fixture to the coating equipment, and apply adhesive to the side of the drum head 2 abutted against the supporting component 3.

During specific implementation, move the complete hot press molded drum head 2 to a trimming fixture to remove the excess portion and trim the edges to ensure that the final dimensions of the drum head 2 meet practical requirements. Then, move the trimmed drum head 2 to coating equipment and spray strong adhesive onto the side of the drum head 2 abutted against t the drum body 1. The adhesive forms an adhesive layer 21 on the drum head 2. During assembly, the adhesive layer 21 bonds to the third flange 12 of the drum body 1 and the supporting component 3 inside the cavity 11, while the extension part 23 of the drum head 2 engages with the third flange 12 of the drum body 1 to achieve a fixed connection between the drum head 2 and the drum body 1. During the trimming process of the drum head 2, the cut-off flash can be recycled and repurposed for packaging, sound insulation or cushioning components, thereby improving material utilization and reducing production costs.

It should be noted that the terms “comprising” and “including” or any variations thereof in this context are intended to cover non-exclusive inclusion. Thus, a process, device, article or method that includes a series of elements not only includes those explicitly listed elements but may also include other elements not explicitly stated or inherent to such process, device, article or method. Without further limitations, an element defined by the phrase “comprising a . . . ” does not exclude the existence of additional identical elements in the process, device, article or method that includes this element.

In the description of the embodiments of the application, it should be understood that terms indicating directions or positional relationships, such as “length”, “width”, “upper”, “lower”, “front”, “rear”, “left”, “right”, “vertical”, “horizontal”, “top”, “bottom”, “inner” and “outer”, are based on the directions or positional relationships shown in the drawings. These terms are used only for the convenience of describing the application and simplifying the description, and do not indicate or imply that the referred devices or elements must have specific orientations or be constructed and operated in specific orientations. Therefore, they should not be construed as limitations on the application.

Furthermore, it should be understood that the terms “first” and “second” are used for descriptive purposes only and should not be construed as indicating or implying relative importance or implicitly specifying the quantity of the indicated technical features. Thus, features defined by “first” and “second” may explicitly or implicitly include one or more such features. In the description of the application, “a plurality of” means two or more, unless explicitly specified otherwise.

The above descriptions are merely preferred embodiments of the application and are not intended to limit the patent scope of the application. Any equivalent structures or equivalent processes derived from the content of the description and drawings of the application, whether directly or indirectly applied in other related technical fields, shall likewise fall within the patent protection scope of the application.

1. An electronic African drum, comprising a drum body and a drum head, wherein the drum head is made of ETPU materials;
the drum head is arranged at one end of the drum body, an adhesive layer is arranged on one side of the drum head, and the drum head is adhered and bonded to the drum body through the adhesive layer;
the drum head is circular, and a flange and an extension part are arranged on the drum head and located on the same side of the drum head;
the drum body also comprises a cavity, a supporting component is arranged in the cavity and abutted against the drum head to support the drum head;
the supporting component comprises a metal plate, a buffer and a bracket;
the bracket is fixedly arranged in the cavity, and the buffer and the metal plate are successively arranged on the bracket;
the metal plate is located between the drum head and the buffer and abutted against the drum head to provide support.

2. The electronic African drum according to claim 1, wherein the flange comprises a first flange and a second flange; the first flange and the second flange are respectively ring-shaped and located on the side of the drum head close to the supporting component;
the first flange is arranged close to the center of the drum head, and the second flange is arranged on the outside of the first flange.

3. The electronic African drum according to claim 2, wherein a third flange protruding outward is arranged at one end of the drum body abutted against the drum head and engages with the extension part.

4. The electronic African drum according to claim 3, wherein a placement slot is arranged on the bracket, and the buffer and the metal plate are respectively placed in the placement slot in sequence.

5. The electronic African drum according to claim 4, wherein the first flange, the second flange and the extension part are integrally formed with the drum head.

6. A drum head manufacturing process for the electronic African drum according to any of claims 1-5, comprising the following steps:
S1. Pre-foam thermoplastic polyurethane (TPU) pellets;
S2. Place the pre-foamed ETPU beads into a drum head mold for heating and softening, and then fuse them into a complete drum head;
S3. Move the drum head to a cutting fixture for trimming;
S4. Apply adhesive to one side of the drum head using coating equipment to form the adhesive layer.

7. The drum head manufacturing process for the electronic African drum according to claim 6, wherein the steps for pre-foaming the thermoplastic polyurethane (TPU) pallets also comprise:
adjust the foaming ratio by regulating gas pressure, temperature and soaking time to control the density and hardness of the drum head.

8. The drum head manufacturing process for the electronic African drum according to claim 6, wherein after the step of pre-foaming the thermoplastic polyurethane (TPU) pellets, the process further comprises the following step: cool and shape the foamed TPU beads to obtain ETPU beads.

9. The drum head manufacturing process for the electronic African drum according to claim 6, wherein after the step of placing the pre-foamed ETPU beads into the drum head mold for heating and softening and then fusing them into the complete drum head, the process further comprises the following step: stop conveying high-temperature steam into the drum head mold, and lower the temperature of the mold cavity through cooling water or compressed air to obtain the finished drum head product with the set shape and size.

10. The drum head manufacturing process for the electronic African drum according to claim 6, wherein after the step of moving the drum head to the cutting fixture for trimming, the process further comprises the following step:
move the drum head from the cutting fixture to the coating equipment, and apply adhesive to the side of the drum head abutted against the supporting component.
